(19) United States
(12) Patent Application Publication
(10) Pub. No.: US 2012/0034701 A1
(43) Pub. Date: Feb. 9, 2012

(54) DEVICE FOR ASSAY OF A LIQUID SAMPLE

(76) Inventors: Oliver Hofmann, London (GB); Alan Mosley, Herfordshire (GB); Gihan Ryu, Surrey (GB); Claire Walshe, London (GB)

(21) Appl. No.: 13/254,662

(22) PCT Filed: Mar. 2, 2010
(86) PCT No.: PCT/GB2010/000365

§ 371 Date: Oct. 27, 2011

(30) Foreign Application Priority Data
Mar. 5, 2009 (GB) 0903846.4

(51) Int. Cl. G01N 21/00; B32B 37/12; B32B 37/14; G01N 21/64; G01N 30/96

(52) U.S. Cl. 436/164; 422/82.05; 422/82.08; 422/69; 156/60

(57) ABSTRACT

Device and detection system comprising two polarising elements and a measuring zone located between said polarising elements, wherein the measuring zone is being bounded on one side by the first polarising element. The device further comprises an inlet reservoir, an outlet reservoir and a flow channel. Method of fabricating said device, comprising the step of depositing an antibody into the measuring zone.

The present invention relates to a detection system, a device for assay, a method of fabricating a device and a method of assay.

There is a well established and growing need for the measurement of analytes, e.g. albumin or troponin I, which are markers for medical conditions, in samples taken from either humans or animals. At the present time the vast majority of tests carried out to measure biological compounds in a sample are carried out using laboratory based equipment. Such tests require transport of the sample to be tested to the laboratory from the place where the sample was taken from. This can cause delays in obtaining the results of the analysis, which may be disadvantageous. Laboratory based analytical systems often use fluorescent measurement of dye molecules to determine the concentration of the analyte. This may be achieved by using a light source, detection optics at 90° to the source (such that light directly from the source is not detected), and a highly sensitive light detector, such as a photomultiplier tube (PMT). Such systems are generally laboratory-based owing to their bulk, expense and the delicate nature of the optical components.

More recently, analytical systems have been developed and commercialised that can be used at sites remote from the laboratory, thereby obviating the need for transportation of the sample and the consequential delay. Such systems normally contain a cartridge or test strip into which a small sample of a test fluid is applied, e.g. for in vitro diagnostic assays the sample may be blood, plasma, serum, urine or amniotic fluid. The cartridge also contains reagents that will selectively bind to or react with the analyte to form a target material or substance of interest such as a compound or complex or reaction mixture. In order to determine the concentration of the analyte, the cartridge is then inserted into a “reader” which uses optical or other means to quantify the compound or complex and thereby determine the concentration of analyte. These cartridge-reader systems have a disadvantage in that in order to achieve the desired test performance they either have to use expensive, bulky optical components for conventional fluorescent measurement, or alternative novel detection technology has to be developed that avoids fluorescent measurement.

Improved arrangements for optically probing a target material or substance of interest have been disclosed using in-line detection systems, that is where the light source, target zone (containing the target material), optical detector and other required optical elements share a common optical path.

However, in order for this system to provide accurate data at meaningful concentrations of the analyte when detecting fluorescent or phosphorescent markers, it is necessary for virtually all of the light from the light source to be eliminated after it has passed through the target material so that it does not reach the light detector and cause anomalous results by swamping the emitted light from the substance of interest. This is difficult to achieve with small, low cost optics in which performance may be compromised.

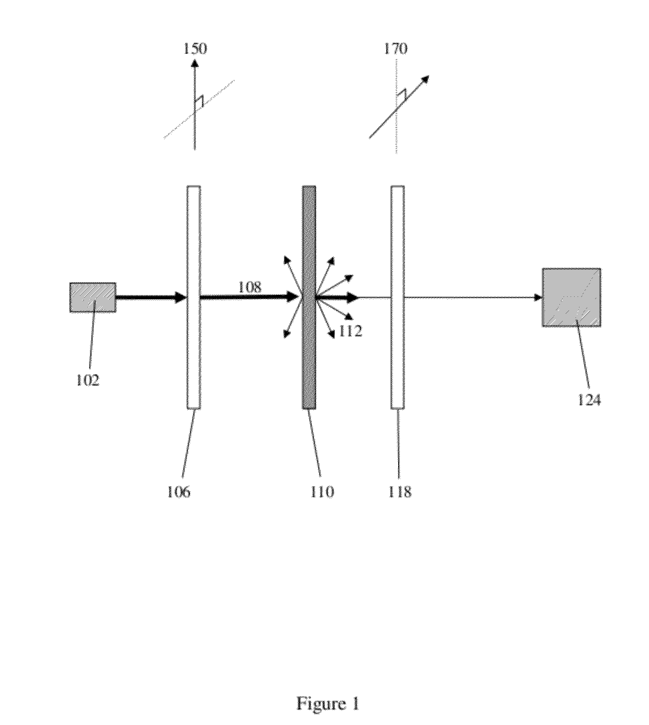

This has been addressed in various prior art systems. An example of a known in-line detection system is shown in FIG. 1 including a light source 102, a first linear polariser 106 having a first polarisation direction 150, a target material 110, a second linear polariser 118 (having a second polarisation direction 170 orthogonal the first polarisation direction 150) and an optical detector 124. Polarised light 108 incident upon the target material 110 may give rise to the emission of unpolarised fluorescent light 112 some of which passes through the second polariser 118 to be detected by the detector 124. Stray polarised light from the source is extinguished by the second polariser owing to the orthogonal polarisation. Such detection systems are, however, still limited in their performance.

Accordingly further prior art systems have been developed, improving on known approaches, for example PCT/GB2008/002527 and PCT/GB2008/002523, incorporated herein by reference, relate to further improved in-line detection systems. According to the improved approach, the first polariser of the in-line detection system shown in FIG. 1 may be replaced by a first linear polariser and a first reflective polariser, and the second polariser may be replaced by a second linear polariser and a second reflective polariser.

A reflective polariser transmits linear polarised light of a first orientation (herein referred to as the polarisation direction in transmission) and reflects linearly polarised light of the orthogonal orientation (herein referred to as the polarisation direction in reflection).

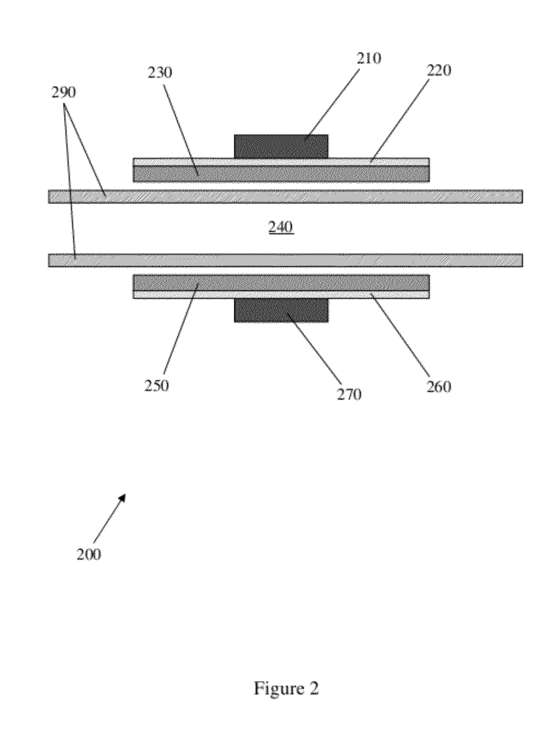

Referring to FIG. 2, there is shown the optical arrangement of such an improved in-line detector 200 comprising, in order, along a common optical axis: an LED 210 acting as light source; a first linear polariser 220; a first reflective polariser 230; a target material contained in a target zone 240; a second reflective polariser 250; a second linear polariser 260; and a detector comprising an organic photodetector 270. The polarisation direction of first linear polariser 220 is substantially orthogonal to the polarisation direction of the second linear polariser 260.

The polarisation direction in transmission of the first reflective polariser 230 is substantially parallel to the polarisation direction of the first linear polariser 220. Therefore, the polarisation direction in reflection of the first reflective polariser 230 is substantially orthogonal to the polarisation direction of the first linear polariser 220.

The polarisation direction in transmission of the second reflective polariser 250 is substantially parallel to the polarisation direction of the second linear polariser 260. Therefore, the polarisation direction in reflection of the second reflective polariser 250 is substantially orthogonal to the polarisation direction of the second linear polariser 260.

In overview, first linear polariser 220 polarises light from the LED 210. This light also passes through the first reflective polariser 230 since the respective polarisation directions of the first linear polariser 220 and first reflective polariser 230 in transmission are substantially parallel. Polarised light is therefore incident upon the target material contained in target zone 240 defined by walls 290 of an optical transparent material. If the target material contains a fluorophore, it will absorb some of the incident light and emit unpolarised fluorescent light. The fluorescent light is unpolarised, hence a portion passes through the second reflective polariser 250 and second linear polariser 260 and is detected by the organic photodetector 270.

A portion of the incident light will be transmitted by the target material and reflected by the second reflective polariser 250 back towards to the target material to cause further fluorescence thereby increasing the detected signal. In other words, the second reflective polariser 250 effectively recycles some of the probe light which did not cause fluorescence on its first pass.

A portion of the fluorescent light will be emitted back towards the source. Some of this light will have a polarisation parallel to the polarisation direction in reflection of the first reflective polariser 230. This light will therefore be reflected back towards the detector. In other words, the first reflective polariser 230 re-directs some of the fluorescent light which would have been otherwise lost.

The in-line nature of the device and the use of a thin film light source and a light detector based on semi-conducting polymers, or small molecules, make it more compact. An optical filter may also be incorporated into the in-line detection system, as set-out in PCT/GB2008/002523, to further improve the device. The improved design of these systems enables the use of low cost and compact light sources and detectors, in particular, which can therefore be incorporated into a portable device.

However, it is further necessary for the material(s) forming the detection chamber (that is, the chamber that defines the target zone—see, for example, walls 290 of FIG. 2) to be optically istotropic so that the polarisation state of the probe light is preserved as it passes through this chamber. Examples of suitable optically isotropic media are glass and cast polymers such as polydimethylsiloxane. However, while such materials have been used, for example, to fabricate small batch sizes of microfluidic chips, such an approach is impractical and uneconomic for the preparation of commercial quantities compared with alternative processes such as injection moulding or hot embossing of plastic material, for example polystyrene.

During the injection moulding process the thermoplastic material will experience high stresses in certain parts of the mould tool, which can lead to the final plastic component becoming optically birefringent with no well defined optical axis. Such materials will depolarise polarised light making them unsuitable for use in the above [symbol] cannot reliably be eliminated. The moulded thermoplastic materials are birefringent enough that even if only one side of the chamber is formed from this process, this severely degrades the sensitivity of the detection system.

The invention is as set out in the claims. The present invention provides an improved detection system and method of fabricating a detection system in which polarising effects caused by the substrate are eliminated. It is found that the improved design has other surprising advantages.

A system is thus provided that can be used for fluorescence assays, including immunoassays, and that is based on low cost detection optics and low cost plastic components that may exhibit optical birefringence.

Embodiments of the invention will now be described by way of example with reference to the drawings in which:

FIG. 1 shows an in-line detector;

FIG. 2 shows an in-line detector in accordance with aspects of the invention;

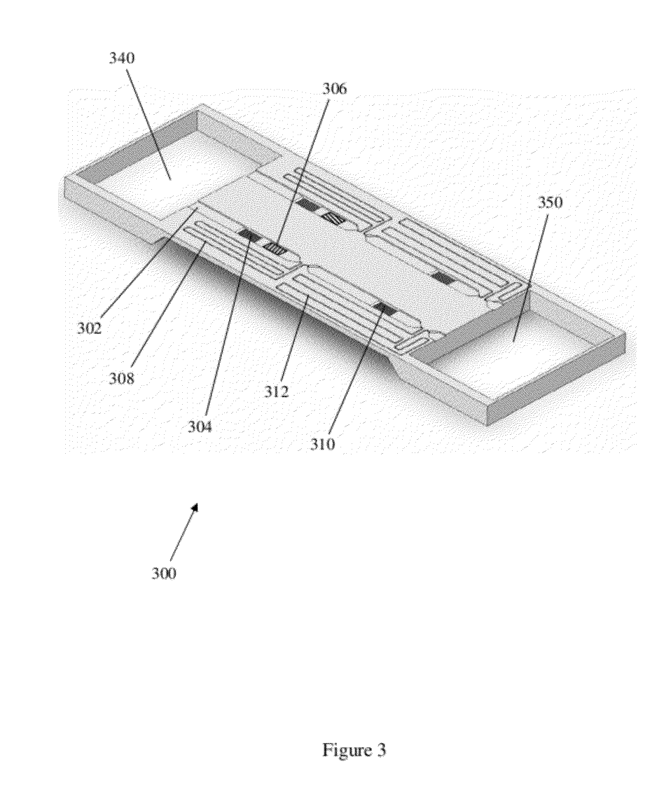

FIG. 3 illustrates a substrate in accordance with embodiments of the invention;

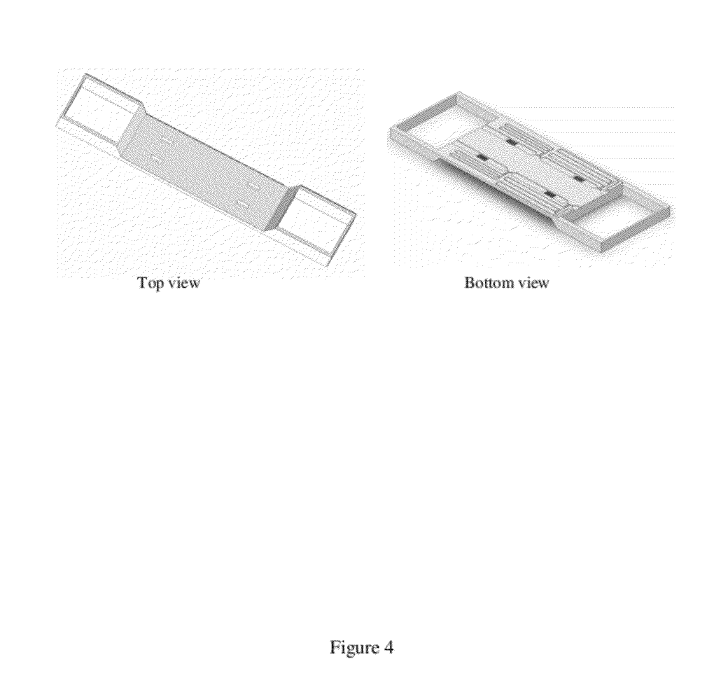

FIG. 4 further illustrates the substrate in accordance with embodiments of the invention.

In overview, the invention provides a detector—for example an optical detector comprising a device for qualitatively or quantitatively detecting light (or other electromagnetic radiation) of a characteristic wavelength or wavelength range, for example, a photodiode—in a detection system comprising a group of components including a light source, target zone and an optical detector. Simplicity of manufacture/assembly is obtained by recognising that the optical measurement zone—for example, a target zone comprising a zone, site, region or volume of space within a detection system that is positioned: (i) within the field of view of the detector; and (ii) to receive light emitted by the light source, or a zone, site, region or volume of space within any device where the optical properties may be probed, analysed, measured or detected by a detection system—can be bound by at least one of the

[symbol]

This technique is applicable to methods of specific-binding assays for quantitatively or qualitatively assaying ligands. For the avoidance of doubt, “ligand” refers to the species under assay and “specific binding partner” refers to a species to which the ligand will bind specifically.

Examples of ligands and specific binding partners which may be used are given below. In each case, either of the pair may be regarded as the ligand with the other as the specific binding partner: antigen and antibody; hormone and hormone receptor; polynucleotide strand and complementary polynucleotide strand; avidin and biotin; protein A and immunoglobulin; enzyme and enzyme cofactor (substrate); lectin and specific carbohydrate.

Embodiments may, for example, be used to assay: antigens, hormones, including peptide hormones (e.g. thyroid stimulating hormone (TSH), luteinising hormone (LH), follicle stimulating hormone, (FSH), human chorionic gonadotrophin (HCG), insulin and prolactin) or non-peptide hormones (e.g. steroid hormones such as cortisol, estradiol, progesterone and testosterone and thyroid hormones such as thyroxine (T4) and triiodothyronine), proteins (e.g. myoglobin, troponin, carcinoembryonic antigen (CEA) and alphafetoprotein (AFP)), drugs (e.g. digoxin), sugars, toxins or vitamins. The term “antigen” as used herein will be understood to include both permanently antigenic species (e.g. proteins, bacteria, bacteria fragments, cells, cell fragments and viruses), and haptens which may be rendered antigenic under suitable conditions.

Embodiments described refer to an antibody or an antigen as the ligand. However, the applicability is not limited to assays of antibodies or antigens, and the invention can be applied to any appropriate detector.

It will be understood that the term “antibody” used herein includes: (a) any of the various classes or sub-classes of immunoglobulin, e.g. IgG, IgM; (b) monoclonal antibodies; and (c) intact molecules or “fragments” of antibodies, monoclonal or polyclonal, the fragments being those which contain the binding region of the [symbol] called “half-molecule” fragments obtained by reductive cleavage of the disulphide bonds connecting the heavy chain components in the intact antibody.

The method of preparation of fragments of antibodies is well known in the art and will not be described herein.

In general, the assay described herein comprises a substrate which receives and processes a target material or substance of interest and at least one detection system which optically probes the processed specimen of interest at a predetermined stage of processing.

Embodiments relate to a form of immunoassay known as a 2-site immunometric assay. In such assays, the analyte is “sandwiched” between two antibodies, one of which is labelled, directly or indirectly, with an entity that can be measured, e.g by optical or electrochemical means (label antibody), and the other is immobilised, directly or indirectly, on a solid support (capture antibody).

In FIG. 3 there is shown one embodiment of a substrate 300 including an inlet reservoir 340 for housing sample liquid prior to use and an outlet reservoir 350 for housing the processed liquid after processing. The substrate 300 comprises at least one channel 302 which provides a physical path for liquid to travel from inlet reservoir 340 to outlet reservoir 350. Each channel, such as channel 302, comprises: a first optical measurement zone 304; a label antibody site 306; a first delay loop 308; a second optical measurement zone 310; and a second delay loop 312.

The first optical measurement zone 304 is a region of the channel where the fluorescence of the sample liquid is measured using an in-line detection system, not shown, such as that described with reference to FIG. 1 or 2. The label antibody site 306 is arranged to contain a quantity of fluorescent labelled antibody that can be released into the fluid stream as fluid passes over it. The second optical measurement zone 310 is a region of the channel where the fluorescence of the processed liquid is measured using a second in-line detection system, not shown, such as that described with reference to FIG. 1 or 2. The second optical measurement zone 310 is

[symbol]

The first delay loop 308 is a portion of channel 302 for increasing the time it takes for liquid to travel from the label antibody site 306 to the second optical measurement zone 310. The second delay loop is a portion of channel 302 for increasing the time it takes for liquid to travel from the second optical measurement zone site 310 to the outlet reservoir 350.

As shown in FIG. 3, the substrate 300 may comprise two or more channels for the detection of different substances.

To form an assay, the target zone 240 of an in-line detection system, such as that described with reference to FIG. 2, forms the first optical measurement zone 304 of the substrate 300 (FIG. 3) and a target zone 240 of a second in-line detection system forms the second optical measurement zone 310 of the substrate 300.

To further form the assay, a quantity of fluorescent labelled antibody is deposited at the site 306 and a quantity of capture antibody is immobilised in the second optical measurement zone 310. The labelled antibody and capture antibody are selected as binding to separate epitopes of the analyte. The unknown quantity of analyte in the liquid for testing will bind to the labelled antibody to form a complex which can bind to the capture antibody immobilised at the second detection site 310. The quantity of labelled antibody captured at the optical measurement zone 310 is a function of the amount of analyte present.

In use, sample liquid for testing, containing an unknown quantity of the analyte, is placed in inlet reservoir 310. By capillarity, sample liquid is drawn into the at least one channel 302. The sample liquid passes the first optical measurement zone 304 which allows for reference measurements to be conducted (e.g. to measure and compensate for sample autofluorescence). The liquid then picks up fluorescent labelled antibody that has been deposited at the site 306. While moving through the first delay loop 308, labelled antibody can bind to the analyte to form an immunocomplex. When arriving in the second optical measurement zone 310 the immunocomplex binds to the immobilised capture antibody. The second delay loop [symbol] immunocomplex reaches the outlet reservoir 320 into which a wick (not shown) is inserted, rinsing of the channel 302 with the remaining sample volume in the inlet reservoir 310 is initiated. This is important to minimise the amount of unbound detection antibody in the second optical measurement zone 310. In the last step, the fluorescence from the second optical measurement zone 310 is measured and, after compensating for measurements from the first optical measurement zone 304, compared to pre-recorded calibration data thus allowing for the quantification of the analyte.

According to the present invention, the simplified assembly can be understood referring to FIG. 4. The substrate may be fabricated by the following steps: adhesive layer applied to the top surface of the device between the inlet and outlet reservoirs; adhesive is removed from the open area forming the optical measurement windows; a first polariser laminated on top; the substrate is turned over for immobilisation of the capture antibody into second optical measurement zone; deposition of labelled antibody into site 306 and sealing of the bottom surface with second polariser coated with adhesive. Optionally, inlet reservoir 340 may house a porous pad containing buffer salts, surfactant or other chemicals to provide an optimum fluid medium for the test.

Accordingly to this approach, the birefringent material, that would normally be used to seal the optical measurement zones, has been removed so that the fluorescent assay can be measured using low cost polarising optics. This allows the substrate to be formed from injection moulded plastic components providing in total a low cost detection device for fluorescent assays.

In an embodiment, the adhesive could be hydrophilic or hydrophobic depending on the required rate of capillary flow and formulation of the sample fluid medium.

Alternatively, the device may be fabricated by other methods such as using one or other polariser pre-patterned with labelled antibody and/or immobilised capture antibody

The skilled person will understand that any polarisers may be suitable, such as Nitto polariser DEG 1425 DU available from Nitto Denko, Japan, or a cholesteric liquid crystal (CLC) based circular polariser.

Alternatively again, the polarisers may be reflective polarisers, for example Dual Brightness Enhancement Film (DBEF), such as DBEF-E available from 3M.

In particular, the inventors have further recognised that the capture antibody may be immobilised directly on the polariser. More specifically, the inventors have found that DBEF has a surface sufficiently hydrophobic to allow immobilisation of the capture antibody through adsorption whilst not excessively hydrophobic to prevent capillary flow through the substrate. In other words, the inventors have identified a material which has excellent optical, physical and chemical properties for this application.

The skilled person will understand that there are many other techniques for immobilising antibodies or antigens onto solid supports such as covalent chemical linking, the use of avidin/biotin, or indirect immobilisation through a second antibody.

In a yet further improvement, the polariser may have an embossed surface which would increase the surface area for capture antibody immobilisation and may help increase the reaction rate by decreasing diffusion times

In an alternative, not shown, a single layer of birefringent film is used to seal either the top or bottom of the optical measurement zones and one of the polarising elements is used to seal the other side. In this case it would be a requirement that the film is optically uniaxial with a well-defined optical axis that could be aligned with the polarising axis of one of the polarising elements. By reducing the number of components, parts and assembly costs are reduced.

At least one boundary of the walls 290 of FIG. 2 is therefore formed by a polarising element rather than the outer walls of a polystyrene casing, for example. In other [symbol] elements. The skilled person will understand that the polarising element may be of any type, for example a linear or reflective (linear or circular) polariser. The skilled person will readily understand that the improvement achieved by the claimed invention is realised by bounding the optical detection zone(s) at the light source side, detector side or both. The skilled person would also understand that a second and orthogonal polarising element may still be required but this could be external to the substrate. The second polarising element is of the same type as the first (i.e linear or circular. It will be appreciated that the optical detection zone can be bounded by the innermost polariser or polarisers according to the configuration described above with reference to FIG. 2 or any other appropriate configuration.

A further improvement to this system is to manufacture the substrate from a plastic material that is substantially optically opaque, for example by doping the plastic material with a pigment or black dye, or coating its outer surfaces with a black paint/lacquer. Because this would prevent a larger portion of background light reaching the detector, the sensitivity of the system is further increased.

In a variation, it is possible to injection mould the optical measurement zone without the upper and lower surfaces and create these in separate processes with non-birefringent materials, e.g. thin pieces of glass or of a non-birefringent polymer, although this would require the use of additional materials.

In the embodiment described herein, the light source is an organic light emitting diode, based on either a small molecule emitter or a light emitting polymer, and the light detector is a broadband photodetector based on organic semiconductors. In a typical system of this kind the light source would have a spectral width of 100 nm at half maximum and the photodetector would detect light from 400-650 nm.

However, it will be appreciated that any appropriate component or material can be adopted. For example, the LED may be an organic LED or an inorganic LED with a peak emission at 501 nm, such as product Osram LVE63C-ABDA-35 from RS Components, or inorganic LED with a peak emission at 470 nm, such as product Kingbright KPTD-3216QBC-C from RS Components.

It can be understood from the above disclosure that the substrate may be manufactured from any thermoplastic material, such as polystyrene or a cyclic polyolefin such as TOPAS.

Any light detector may be suitable, such as an organic light detector based on an active layer formed from a 50:50 blend of 1-(3-Methoxycarbonylpropyl)-1-phenyl-[6.6]C61 (commonly known as PCBM) and poly(3-hexylthiophene) (commonly known as P3HT). The skilled person will understand that the term detector includes qualitative and quantitative detection or measurement of radiation of a characteristic wavelength or wavelength range.

The skilled person will understand that the present invention is equally applicable to analyses other than in vitro diagnostics, for example environmental, veterinary and food analysis.

It can also be understood that the invention is equally applicable to heterogeneous, homogeneous immunoassays, fluorescent dye binding assays and other assay formats.

The skilled person will understand that the present invention is not limited to microfluidics. Furthermore, the invention is compatible with other fluid motivated approaches such as centrifugal force systems, electro-osmotic flow based pumping, pressure driven pumping and minifluidics. As discussed earlier, the approach can be adopted for any sample and assay including single and multiple detection sites, and the use of antibodies or other approaches.

The technology may also be applied to microarrays with multiple zones deposited onto polarisers enabling construction of low-cost microarray system with OLED array/organic detector based read-out.

There is also provided a method of immobilising a capture antibody comprising one of adsorbing, covalently linking, directly or indirectly immobilising the antibody onto DBEF.

1-19. (canceled)

20. A detection system comprising a light source, a photodetector, an optical measurement zone therebetween and at least a first polarising element for polarising light between the source and photodetector, the optical measurement zone being bounded on one side by said first polarising element.

21. A detection system according to claim 20 wherein the first polarising element is a first reflective polariser.

22. A detection system according to claim 21 wherein the first reflective polariser is a Dual Brightness Enhancement Film.

23. A detection system according to claim 20 wherein the first polarising element is a linear or circular polariser for example a cholesteric liquid crystal based (CLC) circular reflective polariser.

24. A detection system according to claim 20 wherein the optical detection zone is further bounded by a second polarising element for polarising light between the source and photodetector.

25. A detection system according to claim 24 wherein the second polarising element is a second reflective polariser.

26. A detection system according to claim 25 wherein the second reflective polariser is a Dual Brightness Enhancement Film.

27. A detection system according to claim 25 wherein the second polarising element is a linear or circular polariser for example a cholesteric liquid crystal based (CLC) circular reflective polariser.

28. A detection system according to claim 24 wherein the first and second polarising elements are at least partially mutually extinguishing.

29. A detection system according to claim 20 wherein the optical detection zone is further bound by a first uniaxial birefringement tape having an optical axis parallel or orthogonal to the polarisation direction of the first polarising element.

30. A detection system according to claim 22 wherein the surface of the first reflective polariser is embossed.

31. A detection system according to claim 26 wherein the surface of the second reflective polariser is embossed.

32. A detection system according to claim 20 arranged for detecting fluorescence within the optical measurement zone.

33. A detection system according to claim 20 wherein the surface of at least the first polarising element can act as the support for an immobilised antibody.

34. A device for assay of a liquid comprising:
at least one detection system comprising a light source, a photodetector, an optical measurement zone therebetween and at least a first polarising element for polarising light between the source and photodetector, the optical measurement zone being bounded on one side by said first polarising element;
a substrate comprising: the optical measurement zone; an inlet reservoir; an outlet reservoir; a channel for facilitating flow of a liquid sample from the inlet reservoir to the optical measurement zone and from the optical measurement zone to the outlet reservoir.

35. A device as claimed in claim 34 wherein the substrate is optically non-transparent.

36. A method of fabricating a device for assay of a liquid comprising at least one at least one detection system comprising a light source, a photodetector, an optical measurement zone therebetween and at least a first polarising element for polarising light between the source and photodetector, the optical measurement zone being bounded on one side by said first polarising element, and a substrate, the substrate comprising the optical measurement zone; an inlet reservoir; an outlet reservoir; a channel for facilitating flow of a liquid sample from the inlet reservoir to the optical measurement zone and from the optical measurement zone to the outlet reservoir, the method comprising:
laminating a first polariser onto a first face of the substrate;
depositing a labelled antibody into a region of the channel between the inlet reservoir and optical measurement zone;
depositing a capture antibody into the optical measurement zone; and
sealing the second face of the substrate with a second polariser coated with adhesive.

37. A method according to claim 36 comprising bounding the optical measurement zone by the first and second polarisers.

38. A method of assay comprising bounding the optical detection zone between at least partially mutually extinguishing polarisers.
